(19) United States
(12) Patent Application Publication
(10) Pub. No.: US 2018/0157311 A1
(43) Pub. Date: Jun. 7, 2018

(54) System-Wide Idle Resiliency Mechanism for Always-On Always-Connected Computers

(71) Applicant: Microsoft Technology Licensing, LLC, Redmond, WA (US)

(72) Inventors: Paresh Maisuria, Redmond, WA (US); M. Nashaat Soliman, Redmond, WA (US); Matthew Holle, Kirkland, WA (US); James Anthony Schwartz, JR., Seattle, WA (US); Gabriel Scannell Knezek, Seattle, WA (US)

(21) Appl. No.: 15/372,242

(22) Filed: Dec. 7, 2016

(51) Int. Cl. G06F 1/32

(52) U.S. Cl. CPC G06F 1/3287

(57) ABSTRACT

Moving a computing system to a mandated power state. The method includes a computing system component determining to move the computing system to a deeper power state. As a result, the method further includes the computing system component directing hardware and software agents on the computing system to move to a deeper power state. The method further includes the computing system component observing that at least one agent is preventing the computing system from moving to the deeper power state. As a result, the method includes the computing system component directing a system-wide movement to a mandated power state.

### BACKGROUND

### Background and Relevant Art

Computers and computing systems have affected nearly every aspect of modern living. Computers are generally involved in work, recreation, healthcare, transportation, entertainment, household management, etc.

New computing scenarios require computing devices to be always available, while still delivering excellent power efficiency. One example might be the need for voice-activated, ambient agents like Cortana available from Microsoft® Corporation of Redmond, Wash. to be available to a user. To meet battery-life goals, systems typically rely heavily on well-behaved software and hardware agents to cooperatively participate in the overall platform power success. Each agent identifies opportunities to reduce power consumption without negatively impacting usability. Thus, a “waterfall” model is a cooperative model where components move to a lower power state, allowing other components to move to a lower power state, culminating in an entire system moving to a lower power state.

However, this cooperative “waterfall” model has a weakness in that a single software or hardware component can negatively impact the entire battery life management for a system. In particular, a single software or hardware component can prevent the system from entering a low-power, battery-saving state.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a computer implemented method of moving a computing system to a mandated power state. The method includes a computing system component determining to move the computing system to a deeper power state. As a result, the method further includes the computing system component directing hardware and software agents on the computing system to move to a deeper power state. The method further includes the computing system component observing that at least one agent is preventing the computing system from moving to the deeper power state. As a result, the method includes the computing system component directing a system-wide movement to a mandated power state.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manlier in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a computing system configured to move a to a mandated, system-wide power state;

FIG. 2 illustrates a graphical representation of various power states which the computing system may be placed into;

FIG. 3 illustrates a flow showing movement to a mandated, system-wide power state; and

FIG. 4 illustrates a method of moving a computing system to a mandated, system-wide power state.

### DETAILED DESCRIPTION

To help mitigate ill-behaved components preventing a system from entering a power saving state, embodiments illustrated herein can use an idle-resiliency mechanism for the overall system. Under certain conditions (for example, all software activity has ceased, but hardware remains active), the system could send a notification to all software and hardware components in the system. The notification directs all components to power themselves down until such time that a user needs the system again.

Thus, embodiments may prevent the reliance on every hardware and software agent in the OS to properly cooperate in a waterfalling scenario in achieving overall system battery-life goals. In general, if a single software agent (which can include 3rd-party software) fails to properly detect cases where peripherals are idle, the overall system is prevented from entering low-power states resulting in degraded battery life.

With reference to a, a system 100 is illustrated. Embodiments can allow a centralized OS power manager 102 to detect cases where one or more agents on the system have failed to properly transition into a deeper power state, The deeper power state is an operating state that consumes less power than the previous state. This is done by turning off power to various hardware agents to conserve power.

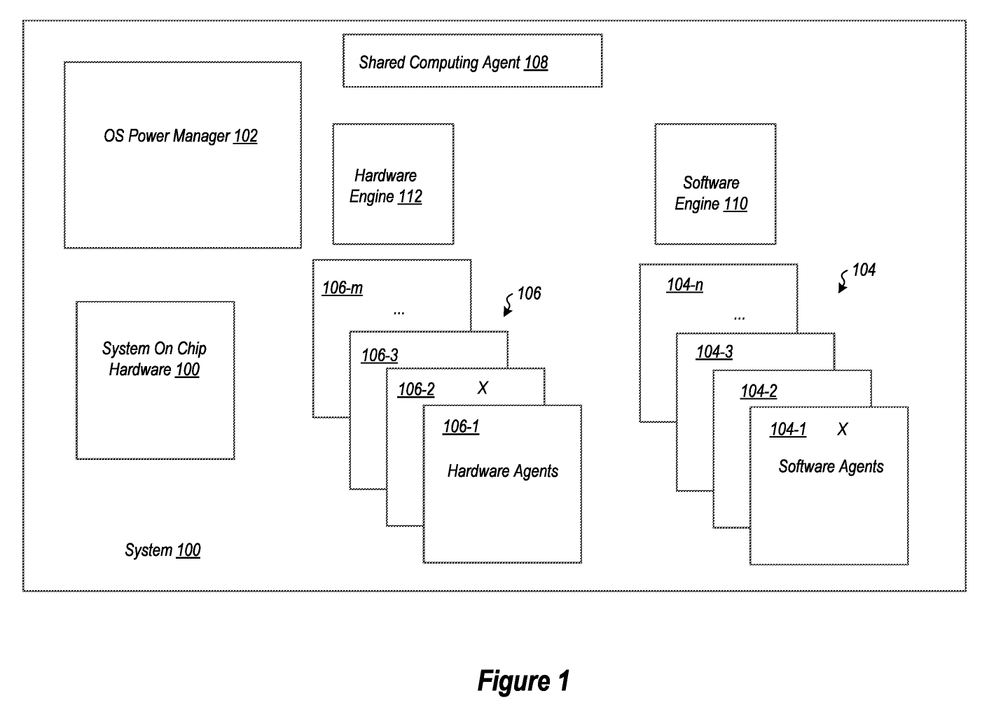

FIG. 1 illustrates software agents 104 including software agents 104-1 through 104-n and hardware agents 106 including hardware agents 106-1 through 106-m. In particular, FIG. 1 illustrates a software agent 104-1 and a hardware agent 106-2 that are preventing the system 100 from entering a target deeper power state. Note that while both a software agent 104-1 and a hardware agent 106-2 are shown as preventing the system 100 from entering the target deeper power state, in some embodiments, either of these alone may prevent the system 100 from entering the target deeper power state.

Typically, the OS power manager 102 will determine that it is appropriate to move the system 100 to a deeper power state. For example, the OS power manager 102 may determine that a user is away from the system 100. This can be determined, for example, by determining that the user has not interacted with the system 100 for a particular amount of time. Alternatively or additionally, in some embodiments, the system 100 maybe coupled to other computing systems usable by the user. The system 100 may have a shared computing agent 108, which is a distributed computing agent, configured to connect to other hardware devices used by the user. The computing system 100 can identify using the shared computing agent 108 that the user is currently using another device in a location that would make it impossible or improbable that the user was using both the other device and the system 100.

Alternatively or additionally, the OS power manager 102 may determine that the system 100 should be moved to a deeper power state by determining that no active software processing or hardware functionality is scheduled to be performed by the system 100. In some embodiments, the OS power manager 102 may use machine learning techniques to determine that the system 100 is unlikely to be used by a user for a given period of time.

In any case, once the OS power manager determines the system 100 should be placed into a deeper power state, the OS power manager 102 will attempt to move the system 100 to the deeper power state, Often, this can be prevented by a malfunctioning hardworking agent or software agent.

In the example illustrated in FIG. 1, a malfunctioning hardware agent 106-2 is illustrated. For example, the hardware agent 106-2 may be a network card, video card, USB connected peripheral, or some other hardware device. The malfunctioning hardware agent 106-2 may have a hardware failure that prevents the hardware agent 106-2 from moving to a deeper power state. Alternatively or additionally, the hardware agent 106-2 may have a malfunctioning driver issue that prevents the hardware agent 106-2 from moving to the deeper power state. Other malfunctions, though not enumerated here, may prevent the hardware agent 106-2 from moving to the deeper power state.

In the example illustrated and FIG. 1, a software engine 110 is configured to monitor the state of the various software agents 104. The software engine 110 can provide notification to the OS power manager 102 that all of the software agents 104 are in a state where they can be placed into the deeper power state. Similarly, the hardware engine 112 monitors the state of the hardware agents 106. The hardware engine 112 can provide notification to the OS power manager 102 that the hardware agents 106 are in a state such that the system 100 can be placed into the deeper power state.

When software agents such as software agent 104-1 or hardware agents such as hardware agent 106-2 malfunction, these malfunctions will cause the software engine 110 and/or the hardware engine 112 to be unable to indicate to the OS power manager 102 that the system can be placed into the deeper power state. When this is due to a malfunction, rather than a legitimate need for a hardware agent or software agent to perform some system activity, this results in a situation where power is unnecessarily consumed by the system 100. In particular, power continues to be supplied to various hardware agents in the system 100 even though those hardware agents are performing no useful tasks.

Embodiments illustrated herein can function by the OS power manager 102 sending an indication to the hardware engine 112 and the software engine 110 that the system 100 is being put into the target deeper power state. The OS power manager 102 can then determine, at some later time, that a malfunctioning software agent and/or a malfunctioning hardware agent is preventing the system 100 from being moved to the deeper power state.

Determining that an agent is preventing the system 100 from moving to the deeper power state can be accomplished in a number of different ways. For example, in most embodiments, the OS power manager 102 will simply determine that a sufficient threshold amount of time has elapsed from when the OS power manager 102 first attempted to move the system to the target deeper power state.

In an alternative embodiment, one or more of the hardware agents 106, software agents 104, hardware engine 112, or software engine 110 may include functionality for responding to a request from the OS power manager 102 to move to the deeper power state. For example, some hardware devices, which may be one or more of the power agents 106, may include state machine hardware that is configured to determine a probability that the hardware device will be needed within some time. Thus for example, the OS power manager 102 may issue a request to move to the deeper power state based on a determination using a state machine at the OS power manager 102 that the system 100 is unlikely to be used for some period of time. However, the state machine in a hardware agent, such as hardware agent 106-2, may determine that the hardware agent 106-2 is likely to be used in some short period of time. Thus, even when the OS power manager 102 and the hardware engine 112 indicate to the hardware agent 106-2 that it should move to a deep the deeper power state, the hardware agent 106-2 may override this request and prevent the hardware agent 106-2 from moving to the deeper power state. This prevents the entire system 100 from moving to the deeper power state.

Note that in some embodiments, the hardware that is preventing the system 100 from moving to a deeper power state may actually be System on Chip (SoC) hardware of the system 100. For example, the SoC hardware may be integrated processors, memory, and storage that implements a computing device such as an embedded computing device or consumer electronic device. The SoC hardware may be under the control of the hardware engine 112.

To remedy this, the OS power manager 102 may be configured to implement a system-wide mandated power state. For example, the OS power manager 102 may cause the entire system 102 hibernate. When this occurs, hardware agents 106 and software agents 104 will be forced into the mandated power state.

Note that this can often have the effect of synchronizing various state machines between the OS power manager 102, the hardware engine 112, the software engine 110, the hardware agents 106, the software agents 104, etc. Thus, when the system 100, after having been moved to the system-wide mandated power state, later moves from the mandated power state, malfunctions of the hardware agent 106-2 and/or the software agent 104-1 may be corrected such that future requests by the OS power manager 102 to move to the deeper power state will be correctly performed.

In cases where agents prevent the system from entering a target power state, the OS power manager 102 will proactively notify all software agents 104 and hardware agents 106 that the system will be entering a system-wide mandated power state. The system-wide mandated power state is typically a different power state than the target power state. In particular, the system-wide mandated power state may be a state that essentially forces hardware and software compliance, resulting in a condition where state between software and hardware can be synchronized. That is, agents are forced into a synchronized state.

Later, the agents can move to a higher power state, such as an active state. However, the agents will likely be synchronized in the higher power state as a result of all of the agents returning from the system-wide mandated power state. This will allow the system 100 to resume an ordinary waterfalling model where individual agents prepare themselves to enter lower power states, and when all agents are prepared to enter lower power states, then the system 100 is able to move to the lower power states.

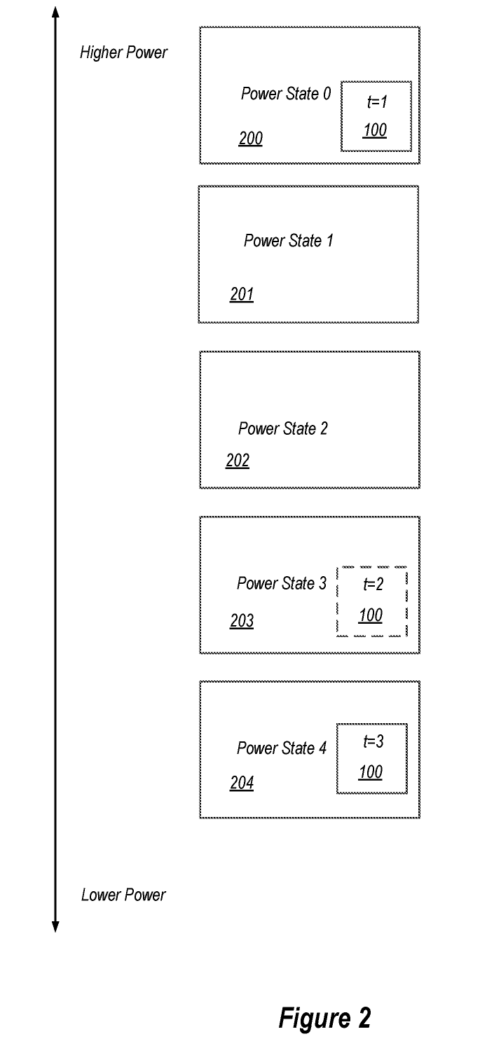

Reference is now made to FIG. 2, which illustrates a number of power states in which the system 100 may operate, in particular, FIG. 2 illustrates five power states 200 through 204. For example, these five power states may be the Si through S5 power states of the Advanced Configuration and Power Interface (ACPI) specification.

The ACPI specification defines four global states and six sleep states. Some of these state may overlap.

Global state G0 and sleep state S0 are the same state. This state is the “Working” state where a computer system is running and hardware is executing tasks.

Global state G1 is the global “Sleeping” state and is sub-divided into four sleep states, S1 through S4.

Sleep state S1 is the Power on Suspend (POS) state. Processor caches are flushed, and all CPUs stop executing instructions. Power to the CPUs and volatile memory, such as RAM, is maintained. Any hardware agents that do not indicate they must remain on may be powered off. However, a misbehaving hardware or software agent can prevent the system 100 from entering this state.

Sleep state S2 is the CPU powered off state. Any modified or “dirty” cache is flushed to RAM, and the CPU is powered off Any hardware agents that do not indicate they must remain on may be powered off. However, a misbehaving hardware or software agent can prevent the system 100 from entering this state.

Sleep state S3 is often referred to as one or more of the Standby, Sleep, or Suspend to RAM (STR) state. In this state, RAM remains powered, but the CPU is powered off and an attempt is made to power off all hardware agents. However, a misbehaving hardware or software agent can prevent the system 100 from entering this state.

Sleep state S4 is often referred to as one or more of Hibernation or Suspend to Disk. All content of the main memory is saved to non-volatile memory such as a hard drive, solid state drive, or other non-volatile medium. The system 100 is powered down. Misbehaving hardware or software agents cannot typically prevent the system 100 from entering this state. Although, some hardware agents may remain powered so the computer can “wake” on input from the keyboard, clock, modem, LAN, or USB device.

Global state G2 (which is the same as sleep state S5) is referred to as the Soft Off state. In this state, the power supply unit supplies power, at a minimum, to the power button to allow return to S0. A full reboot is required. No content from the memory is retained. Some hardware agents may remain powered so the computer can “wake” on input from the keyboard, clock, modem, LAN, or USB device.

Global state G3 is referred to as Mechanical Off in this state, the computer's power has been removed. This can be done, for example, by a mechanical switch preventing power from being supplied to the power supply unit, by a power cord to the power supply being removed, by a battery being removed, or some combination thereof. Some very low power devices, such as a system real time clock or other BIOS components, may continue to operate by using power supplied by a low-power, semi-permanently installed battery

In the example illustrated herein, the power states 200 through 204 illustrated in FIG. 2 may be implemented as the sleep power states S0 through S4 of the ACPI specification. However, other standard power states or custom power states may be implemented alternatively or additionally. The comparison of power states 200 through. 204 to the sleep power states S0 through S4 of the ACPI specification are for illustration purposes only.

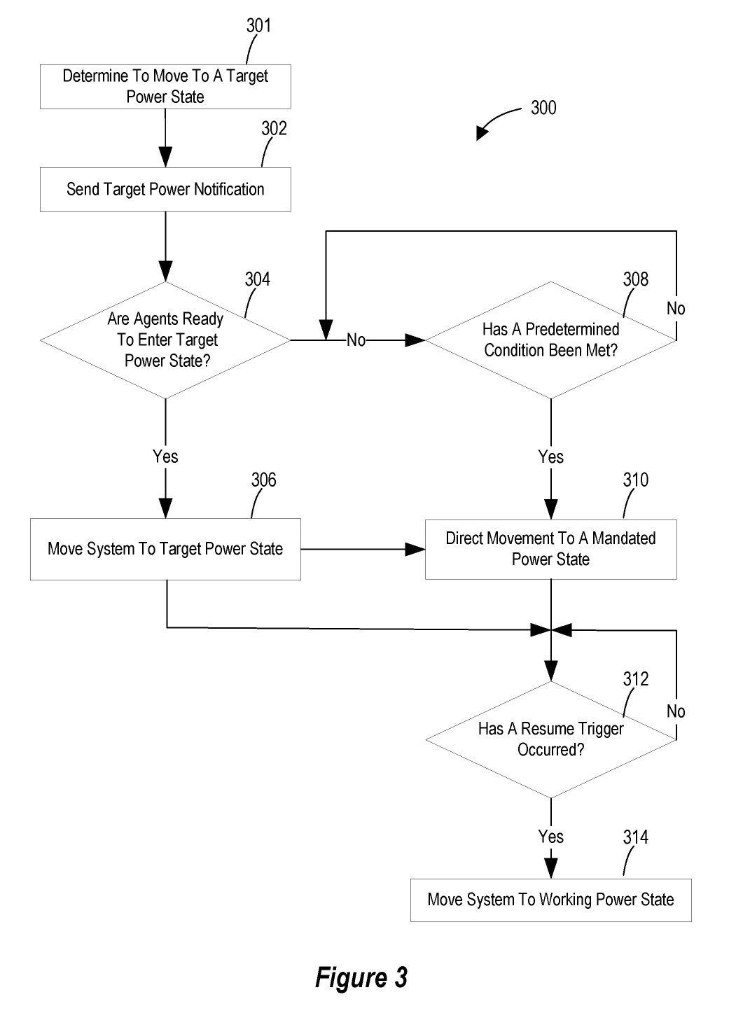

An example scenario is now illustrated with reference to FIGS. 2 and 3. With reference to FIG. 2, the system 100 a first time t=1 is operating at power state 0 200. As illustrated at 301, the system 100, and in particular, the OS power manager 102 may determine to move the system 100 to a target power state, such as power state 3, 203 that consumes less energy than power state 0 200. The determination to move the system to the target power state may be based on one or more of a number of different factors.

For example, the power manager 102 may determine that no substantial (according to sonic predetermined threshold) computing operations are scheduled to be performed by the system 100, or that no substantial (according to some predetermined threshold) computing operations are scheduled to be performed by the system 100 within some predetermined time period. Alternatively or additionally, the power manager 102 may determine that a user of the system 100 is not in proximity to the system 100, and is therefore unlikely to use the system 100. This could be based on sensors that the system 100 that could detect the presence of the user. For example, user interface devices such as mice, touch screens, touch pads, keyboards, etc., may have been idle for some predetermined period of time. Alternatively or additionally, infrared sensors, cameras, and the like can be used to detect the presence of a user at the system 100.

In still other embodiments, the system 100 maybe associated with other systems used by the user and may communicate with these other systems. The system 100 can determine that the user is using a different system associated with the user making it unlikely, or in some situations impossible, for the user to use the system 100 within sonic temporal lee proximate time period.

Referring once again to FIG. 3, as illustrated at 302, at time t=2,as a result of determining to move the system 100 to a target power state, the OS power manager 102 may send a notification to the various agents in the system 100, such as the hardware agents 106 and the software agents 104, to move to the target power state. For example, the OS power manager 102 may direct the various agents in the system to move to the power state 3, 203.

As illustrated at 304, a determination may be made as to whether or not the agents are ready to enter the target power state, in this case, power state 3, 203. This may be accomplished by identifying whether or not the agents are performing work, generating outputs, have a particular register state, or have some other state indicating whether or not they are ready to move to the target power state. In some embodiments, this may be further accomplished by hardware agents 106 being monitored by a hardware engine 112 that can determine if the hardware agents are ready to move to the target power state and/or software agents 104 being monitored by the software engine 110 that can determine if the software agents are ready to move to the target power state.

If the software agents 104 and hardware agents 106 are ready to move to the target power state (e.g., state 203), then, as illustrated at 306, the system 100 can be moved to the target power state.

However, if the software agents 104 and hardware agents 106 are not ready to enter the target power state, then as illustrated at 308, embodiments the OS power manager 102) may be configured to determine if some other predetermined condition has been met.

For example, embodiments may determine that software agents and/or hardware agents have not been ready to enter the target power state for some predetermined period of time from when the target power notification at 302 was sent.

Alternatively or additionally the predetermined condition may include a number of times that a notification has been sent to put the system 100 into the target power state.

Alternatively or additionally, the predetermined condition may include receiving a negative acknowledgement from the hardware engine 112, one or more of the hardware agents 106, the software engine 110 or one or more of the software agents 104. In particular, one or more of these entities may include functionality for rejecting a notification to move to the target power state. For example, these entities may include a state machine that determines that the entity anticipates being used in a short period of time or some other condition that would point against moving to the target power state.

Note that combinations of the above may be evaluated as the predetermined condition evaluated at 308 in FIG. 3.

As illustrated in FIG. 3, if the predetermined condition has been met, than as illustrated at 310, at time t=3, embodiments (e.g., the OS power manager 102) can direct movement of the system 100 to a mandated power state. In this case, the mandated power state. In the example illustrated in FIG. 2, the mandated power state is power state 4, 204. The mandated power state may be a power state which can force agents into the mandated power state. For example, the mandated power state may be an S3 power state in the ACPI specification.

Note that while particular ACPI specification sleep power states have been illustrated, it should be appreciated the other power states, including custom power states may be used in addition or alternatively. Thus, while often the target power state may be the S3 power state, and the mandated power state may be the S4 power state, it should be appreciated that other states may be used as these states in the example above. For example, the target power state could be S1 or S2 (or some other custom power state) and the mandated power state could be S3 or S4 (or some other custom power state). While not illustrated here, other permutations may be alternatively or additionally implemented.

Note that in some embodiments, the mandated power state could actually be a higher power state followed by attempting to move the system to a lower power state. For example, in some embodiments there may be mitigation steps that require hardware agents to move to a higher power state before they can be moved to a lower power state. For example, a hardware card, such as a Wi-Fi card may need to be moved to a higher power state before it can be moved to a lower power state.

Referring once again to FIG. 3, FIG. 3 illustrates at 312 that a determination can be made as to whether or not a resume trigger as occurred. Such a resume trigger may include a power button being pressed, a network trigger for wake on LAN, a laptop lid being opened, or other appropriate trigger. When the mandated power state is S3 or S4, the only trigger available will often only be a power button press.

As illustrated in FIG. 3, if the trigger occurs, then, as illustrated at 314 the system 100 may be moved to a working power state, power state 0 200, such as state S0.

Embodiments described herein may allow for a simplified system that could be responsive to new system hardware and/or software being added to the system 100 without needing to design specific functionality capable of specifically handling the new system hardware and/or software. Rather, incompatible hardware or software which might prevent the system 100 from entering a target power state could nonetheless be forced into a system-wide mandated power state.

Any hardware agent or software agent that is capable of waking the system 100, will have been previously armed for wake such that activity from that agent will resume the system to a working power state from the system-wide mandated power state.

Embodiments can continue to maintain and support existing “waterfall” power models where individual software agents and device drivers are able to self-manage their idle detection and power states.

The OS power manager 102 can detect cases where all software should be inactive but is not. Some examples might be that the user is not present and will not be for an extended period of time. For these given cases, the OS power manager will send a system-wide notification which will serve two purposes: first it will signal intent to all software agents that they should stop their activity, and second, it will signal hardware driver stacks to send their respective hardware into a low-power state.

The OS power manager can leverage new, more modern platform sleep states that maintain support for modern scenarios like Connected Standby.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

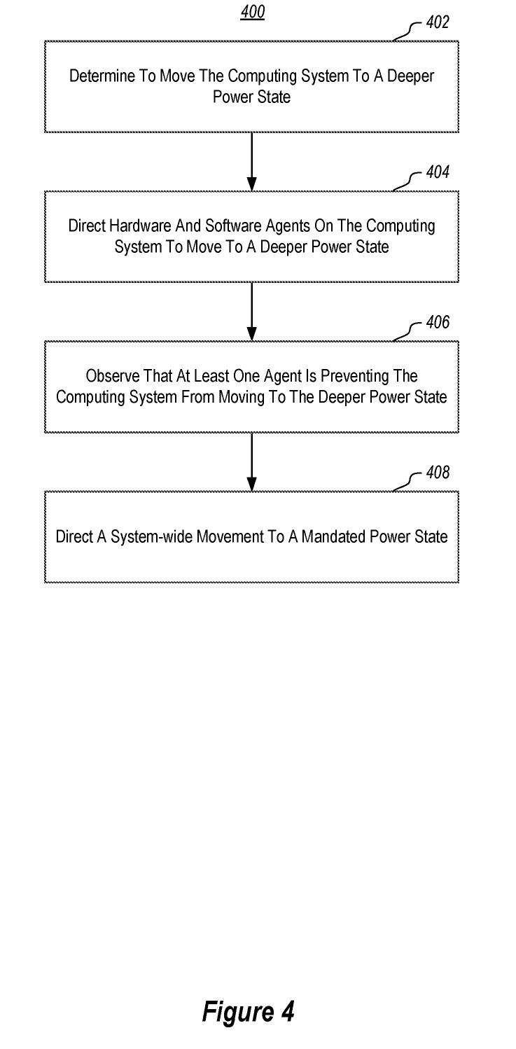

Referring now to FIG. 4, a method 400 is illustrated. The method 400 is a computer implemented method of moving a computing system to a mandated power state (such as a hibernate state). The method 400 includes a computing system component (such as an OS power manager) determining to move the computing system to a deeper power state (act 402), such as sleep state. This may occur, for example, when the OS power manager determines that no significant, according to some predetermined criteria, computing or hardware tasks are scheduled to be performed.

As a result, the method 400 further includes the computing system component directing hardware and software agents on the computing system to move to a deeper power state (act 404). For example, the OS power manager may indicate to the software agents 104 and the hardware agents 106 that they should move to a deeper power state, such as a sleep state.

The method 400 further includes the computing system component observing that at least one agent is preventing the computing system from moving to the deeper power state (act 406). However, it should be appreciated that the at least one agent could be known or unknown and observation could be observed directly or indirectly. For example, the system component may simply observe that the computing system is not moving toward the deeper power state. For example, embodiments may wait some predetermined length of time, and if the system does not move toward the deeper power state in the predetermined time, then it would be determined that an agent is preventing the computing system from moving to the deeper power state. Thus, in this case, the particular agent would be unknown, and the observation would be indirect. In an alternative example, a particular component may include functionality for indicating to the OS power manager that it is unable to move to the deeper power state or that it is refusing to move to the deeper power state due to anticipated work or for other reasons, Notably, in some embodiments, agents may include functionality for identifying reasons that they will not move to the deeper power state. In some embodiments, agents may be able to generate interrupts to the OS as part of indicating that they will not move to the deeper power state. Alternatively or additionally, the agents may be able to respond to polling or other requests.

Returning once again to the method illustrated in FIG. 4, as a result, the method 400 further includes the computing system component directing a system-wide movement to a mandated power state (act 408). For example, while the deeper power state may be a sleep state, the mandated power state may be a hibernate state, which is a system-wide power state.

The method 400 may be practiced where the at least one agent that is preventing the computing system from moving to the deeper power state is a hardware agent. Alternatively or additionally, the at least one agent that is preventing the computing system from moving to the deeper power state may be a software agent.

Time method 400 may be practiced where observing that at least one agent is preventing the computing system from moving to the deeper power state includes indirectly observing that at least one agent is preventing the computing system from moving to the deeper power state by observing that the computing system is not moving to the deeper power state after a predetermined period of time.

The method 400 may be practiced where observing that at least one agent is preventing the computing system from moving to the deeper power state includes receiving feedback from the at least one agent indicating that the agent will not move to the deeper power state. The feedback could be, for example, directly from the agent itself, or could be from a manager, such as a hardware or software manager. In some embodiments, the at least one agent provides information indicating why the agent cannot move to the deeper power state.

The method 400 may further include moving the system to a higher power state prior to directing the system-wide movement to the mandated power state. For example, the system may need to move to a higher power state to put certain agents into the higher power state before they are able to be put into the system-wide mandated power state. For example, embodiments may need to bring a Wi-Fi adapter or other hardware to a higher power state required to move the hardware to the system-wide mandated power state.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media, Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data. which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data rinks, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system comprising:
one or more processors; and
one or more computer-readable media having stored thereon instructions that are executable by the one or more processors to configure the computing system to move the computing system to a deeper power state, including instructions that are executable to configure the computing system to perform at least the following:
determine to move the computing system to a deeper power state;
as a result, direct hardware and software agents on the computing system to move to a deeper power state;
observe that at least one agent is preventing the computing system from moving to the deeper power state; and
as a result, direct a system-wide movement to a mandated power state.

2. The computing system of claim 1, wherein the at least one agent that is preventing the computing system from moving to the deeper power state is a hardware agent.

3. The computing system of claim 1, wherein the at least one agent that is preventing the computing system from moving to the deeper power state is a software agent.

4. The computing system of claim 1, wherein observing that at least one agent is preventing the computing system from moving to the deeper power state comprises indirectly observing that at least one agent is preventing the computing system from moving to the deeper power state by observing that the computing system is not moving to the deeper power state after a predetermined period of time.

5. The computing system of claim 1, wherein observing that at least one agent is preventing the computing system from moving to the deeper power state comprises receiving feedback from the at least one agent indicating that the agent will not move to the deeper power state,

6. The computing system of claim 5, wherein the at least one agent provides information indicating why the agent cannot move to the deeper power state.

7. The computing system of claim 1, wherein one or more computer-readable media further have stored thereon instructions that are executable by the one or more processors to configure the computing system to move the computing system to a higher power state prior to directing the system-wide movement to the mandated power state.

8. A computer implemented method of moving a computing system to a mandated power state, the method comprising:
a computing system component determining to move the computing system to a deeper power state;
as a result, the computing system component directing hardware and software agents on the computing system to move to a deeper power state;
the computing system component observing that at least one agent is preventing the computing system from moving to the deeper power state; and
as a result, the computing system component directing a system-wide movement to a mandated power state.

9. The method of claim 8, wherein the at least one agent that is preventing the computing system from moving to the deeper power state is a hardware agent.

10. The method of claim 8, wherein the at least one agent that is preventing the computing system from moving to the deeper power state is a software agent.

11. The method of claim 8, wherein observing that at least one agent is preventing the computing system from moving to the deeper power state comprises indirectly observing that at least one agent is preventing the computing system from moving to the deeper power state by observing that the computing system is not moving to the deeper power state after a predetermined period of time.

12. The method of claim 8, wherein observing that at least one agent is preventing the computing system from moving to the deeper power state comprises receiving feedback from the at least one agent indicating that the agent will not move to the deeper power state.

13. The method of claim 12, wherein the at least one agent provides information indicating why the agent cannot move to the deeper power state.

14. The method of claim 8, further comprising moving the system to a higher power state prior to directing the system-wide movement to the mandated power state. May need to signal higher power state.

15. One or more computer-readable storage media having stored thereon instructions that are executable by one or more processors to configure the computing system to move the computing system to a deeper power state, including instructions that are executable to configure the computing system to perform at least the following:
determine to move the computing system to a deeper power state;
as a result, direct hardware and software agents on the computing system to move to a deeper power state;
observe that at least one agent is preventing the computing system from moving to the deeper power state; and
as a result, direct a system-wide movement to a mandated power state.

16. The one or more computer-readable storage media of claim 15, wherein the at least one agent that is preventing the computing system from moving to the deeper power state is a hardware agent.

17. The one or more computer-readable storage media of claim 15, wherein the at least one agent that is preventing the computing system from moving to the deeper power state is a software agent.

18. The one or more computer-readable storage media of claim 15, wherein observing that at least one agent is preventing the computing system from moving to the deeper power state comprises indirectly observing that at least one agent is preventing the computing system from moving to the deeper power state by observing that the computing system is not moving to the deeper power state after a predetermined period of time.

19. The one or more computer-readable storage media of claim 15, wherein observing that at least one agent is preventing the computing system from moving to the deeper power state comprises receiving feedback from the at least one agent indicating that the agent will not move to the deeper power state.

20. The one or more computer-readable storage media of claim 19, wherein the at least one agent provides information indicating why the agent cannot move to the deeper power state.
